(19) United States
(12) Patent Application Publication
(10) Pub. No.: US 2026/0252536 A1
(43) Pub. Date: Aug. 27, 2026

(54) METHOD AND SYSTEM FOR SEMANTIC MODEL AUTOMATION

(71) Applicant: NetApp, Inc., San Jose, CA (US)

(72) Inventors: Grandhi Akhil Sai Manoj, Andhra Pradesh (IN); Prasanna Adithan S M, Tamil Nadu (IN)

(21) Appl. No.: 19/061,828

(22) Filed: Feb. 24, 2025

(51) Int. Cl. G06F 16/21; G06F 16/25

(52) U.S. Cl. CPC G06F 16/214; G06F 16/258

(57) ABSTRACT

Techniques are provided for parsing and transforming one or more queries using semantic model automation. A platform may store data according to a first format and structure. For example, a reporting platform may store operational data as a project that can be used for generating reports through the reporting platform. The project may not be compatible with other platforms that support other formats and structures. Accordingly, the disclosed technology is used for parsing a query targeting the project to identify components used by the reporting platform to organize the data. The components are used to generate one or more custom queries to retrieve data and metadata of the project. The data and metadata is used to create a model having a format and structure supported by a different reporting platform such that the project can be migrated between different reporting platforms supporting different formats and structures of data.

### TECHNICAL FIELD

Various embodiments of the present technology relate to using semantic model automation functionality for parsing and transforming database queries.

### BACKGROUND

Many applications and services store data within databases or other data repositories that are accessible through queries such as structured query language (“SQL”) queries. SQL queries are used to store, manipulate, and retrieve the data in the databases. A SQL query may include a SQL statement such as a SQL select statement used to specify columns and/or rows of data to select from database objects. A software platform, such as a business intelligence visualization and reporting platform, may store data of a project within a database. The software platform may utilize SQL queries to store and manage the data of the project within tables and other database objects within the database. In this way, the software platform stores the data according to a particular format that is structured and semantically tailored to the software platform. That is, the tables and columns, relationships between the tables and columns, security and user roles, formatting and structure, and other components used by the software platform to organize the project within the database may be specific to the software platform. Thus, other software platforms may be unable to access or utilize the data of the project such as to migrate the project from the software platform to a different software platform.

### DESCRIPTION OF THE DRAWINGS

Embodiments of the present technology will be described and explained through the use of the accompanying drawings in which:

FIG. 1 is a block diagram illustrating an embodiment of a system for implementing semantic model automation functionality for query parsing and transformation, where a project is migrated from a source reporting platform to a destination reporting platform as a model, in accordance with an embodiment of the present technology.

FIG. 2 is a block diagram illustrating an embodiment of a system for implementing semantic model automation functionality for query parsing and transformation, in accordance with an embodiment of the present technology.

FIG. 3 is a block diagram illustrating an embodiment of a system for implementing semantic model automation functionality for query parsing and transformation, where a query is transformed into a model, in accordance with an embodiment of the present technology.

FIG. 4 is a flow chart illustrating an embodiment of a method for implementing semantic model automation functionality for query parsing and transformation, where a project is migrated from a source reporting platform to a destination reporting platform as a model, in accordance with various embodiments of the present technology.

FIG. 5A is a block diagram illustrating an embodiment of a system for implementing semantic model automation functionality for query parsing and transformation, where a migration tool establishes a connection with a source reporting platform, in accordance with an embodiment of the present technology.

FIG. 5B is a block diagram illustrating an embodiment of a system for implementing semantic model automation functionality for query parsing and transformation, where a migration tool extracts information from components of a source reporting platform, in accordance with an embodiment of the present technology.

FIG. 5C is a block diagram illustrating an embodiment of a system for implementing semantic model automation functionality for query parsing and transformation, where a migration tool populates structures within a model, in accordance with an embodiment of the present technology.

FIG. 5D is a block diagram illustrating an embodiment of a system for implementing semantic model automation functionality for query parsing and transformation, where a migration tool validates a model, in accordance with an embodiment of the present technology.

FIG. 6A illustrates examples of functions implemented by semantic model automation functionality, in accordance with an embodiment of the present technology.

FIG. 6B illustrates examples of functions implemented by semantic model automation functionality, in accordance with an embodiment of the present technology.

FIG. 6C illustrates an example of a query that is transformed into a model displayed through a user interface, in accordance with an embodiment of the present technology.

FIG. 6D illustrates an example of a report generated from a model, in accordance with an embodiment of the present technology.

FIG. 7 is a flow chart illustrating an embodiment of a method for implementing semantic model automation functionality for query parsing and transformation, in accordance with various embodiments of the present technology.

FIG. 8 is a block diagram illustrating an embodiment of a system for implementing semantic model automation functionality for query parsing and transformation, in accordance with various embodiments of the present technology.

FIG. 9 is a block diagram illustrating an example of a node in accordance with various embodiments of the present technology.

FIG. 10 is an example of a computer readable medium in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Many organizations utilize reporting computing platforms that provide data analysis, visualization and reports, and business intelligence. A reporting platform is a business intelligence computing tool that stores, organizes, and visualizes data. The reporting platform provides tools for reporting and analysis, such as interactive dashboards, operational reports, search and ad hoc queries to obtain data insight, etc. The reporting platform presents data through graphs, tables, charts, or other visual formats. The reporting platform stores data within data storage such as a database that is accessible using database queries including SQL queries.

The reporting platform structures and formats data within tables, columns, and other database objects and components according to a particular format, structure, and/or schema that may be proprietary to the reporting platform. That is, the reporting platform may create and utilize certain components such as tables, columns, relationships between tables and columns, roles, annotations, expressions, filters, and/or other fields or structural components to store and maintain data. The components may form a project hosted by the reporting platform. The project maintains the data within particular tables and other components according to the format supported by the reporting platform.

The structure and format of these components may be unknown and/or inaccessible to applications, services, and other platforms external to the reporting platform. The inability to understand the structure and format of how the data is maintained makes external access to the data complex, difficult, time consuming, and requires a significant amount of manual effort that can be error prone. The complexity and error prone manual effort hinders the ability to provide functionality for the data or project that is not natively supported or provided by the reporting platform. For example, manually identifying, accessing, and migrating the data of the project from the reporting platform to a different reporting platform may require days of extensive manual effort that is tedious and prone to errors and mistakes. Migration of a project hosted by a source reporting platform is difficult because the source reporting platform may natively support a format that is different than a format supported by a destination reporting platform (e.g., migration of a project from an Oracle Business Intelligence Enterprise Edition (OBIEE) platform and/or Tableau to a Power Business Intelligence (PowerBI) (without derogation of any third party trademark rights) platform that does not support projects but supports models).

As an example of manually migrating the project, a user typically has to review and fully understand a SQL query for the project to manually enumerate components of the source reporting platform. The components may include tables, columns, join clauses, filters, measures, and/or other fields used by the source reporting platform to store and maintain data of the project within a data store such as a database. The user then establishes a connection with the data store, and manually retrieves data tables using the components enumerated by the user from the SQL query. The user manually performs transformations such as by renaming or converting columns names to adhere to a format supported by the destination reporting platform. The user then loads the data from the data tables, using the renamed columns, into the destination reporting platform as a model adhering to the format supported by the destination reporting platform. The user also manually hides any columns that are to be hidden in the model. The user then creates relationships, defines roles, and implements row-level security and/or object level security for the model. The user has to develop hierarchies, calculate columns, measures, and/or other elements within the destination reporting platform for the model. In this way, the user may have to spend 3 to 4 days of complex and error prone manual effort to migrate the project from the source reporting platform to the destination reporting platform as a manually constructed model created by the user from scratch (e.g., manually migrating an OBIEE project or Tableau report to PowerBI as a model) (without derogation of any third party trademark rights).

The disclosed techniques improve upon conventional manual task based migration techniques that are complex, time consuming, and error prone by implementing semantic model automation functionality. The semantic model automation functionality provides database query parsing and output transformation functionality that can migrate and transform a project as a model within minutes instead of days. The semantic model automation functionality implements a query parser configured to parse database queries (e.g., SQL queries) to understand the structure, format, and organization of data targeted by the queries. A query may target a project of a source reporting platform, which is to be migrated from the source reporting platform to a destination reporting platform. The query may target other types of data that are to be annotated, transformed, and/or reformatted by the semantic model automation functionality. The query parser is configured with custom parsing functions to parse text of the query, such as text of a SQL statement. The text may identify components used by the source reporting platform. The query parser may parse the SQL statement to identify components such as column names, table names, relationship, filters, etc. The query parser inputs the components into a semantic model automation functionality for further processing such as for migrating of the project, annotating SQL query output, etc.

In some embodiments, the semantic model automation functionality annotates the results from parsing the query, such as by transforming or adding (annotating) additional information into the output from the query based upon the parsed results. The semantic model automation functionality executes functions to perform various tasks such as handling annotations, expressions, relationships, roles, tables, and/or other components (structural elements) for various use cases such as the migration of the project. In some embodiments, the semantic model automation functionality performs annotation handling for understanding SQL objects such as tables, views, columns, table functions, procedures, and parameters that are annotated with additional insight that can be parsed and understood by the semantic model automation functionality for understanding the structure, format, and organization of data within the database. Understanding the structure, format, and organization of the data provides the semantic model automation functionality with insight into how data is maintained within tables and relationships amongst the data in different tables, along with how the data is viewed and operated upon by processor executable functions. The insight can be used to perform various operations such as transforming and/or migrating data stored within a database.

For migrating the project, the semantic model automation functionality utilizes the components, used to identify the structure and format of the data, to extract the data from the source reporting platform (e.g., extracting data and corresponding metadata from tables storing a project hosted by OBIEE). The semantic model automation functionality executes functions to transform the extracted data and metadata into a model that is compatible with and natively supported by the destination reporting platform (e.g., a semantic model supported by PowerBI). In particular, the semantic model automation functionality uses the data and metadata to generate code that constructs custom queries and corresponding tables, columns, annotations, measures, security and roles, relationships, conditions (e.g., join conditions, conditions for merging tables, etc.), calculated columns, hierarchies, column formatting, renamed columns, hidden columns, code for creating visuals, layouts, and reports through the destination reporting platform, etc. In this way, the semantic model automation functionality generates a model (e.g., generates JSON (Java script Object Notation) code for a file, such as a building information model file (.bim file), that can be loaded into PowerBI for viewing and organizing business data, generating reports, etc.). In this way, the semantic model automation functionality programmatically automates the transformation, annotation, and/or migration of data targeted by a SQL query into a different format that is interpretable and natively supported by a destination application, service, or platform.

In addition, various embodiments of the present technology provide for a wide range of technical effects, advantages, and/or improvements to computing systems and components. For example, various embodiments may include one or more of the following technical effects, advantages, and/or improvements: 1) a custom query parser (e.g., a custom SQL query parser) configured to parse queries to identify, extract, and transform components used to structure, maintain, and represent data such as a project through a source reporting platform; 2) semantic model automation functionality configured to parse and annotate output of a query for various use cases; 3) quickly and efficiently migrating a project or other data from a source application, service, or platform to a destination application, service, or platform by automating the migration process to reduce or eliminate complex manual tasks that can take days instead of hours and are susceptible to human errors and mistakes (e.g., an 80% to 90% reduction in manual effort, and a reduction of migration time from 3 to 4 days down to approximately 30 minutes); 4) transforming a project from a structure and format natively supported, interpretable, and/or proprietary to a source application, service, or platform into a different structure and format natively supported, interpretable, and/or proprietary to destination application, service, or platform (e.g., transforming a project from OBIEE into JSON code for a . bim file supported by PowerBI); 5) accessing backend code of a reporting tool (e.g., Tableau used to provide reports and visuals of data) for generating new code to reconstruct reports and/or visuals within the destination platform; and/or 6) validating a model to ensure that the model adheres to specific requirements of an organization, and generating suggestions to address any identified issues.

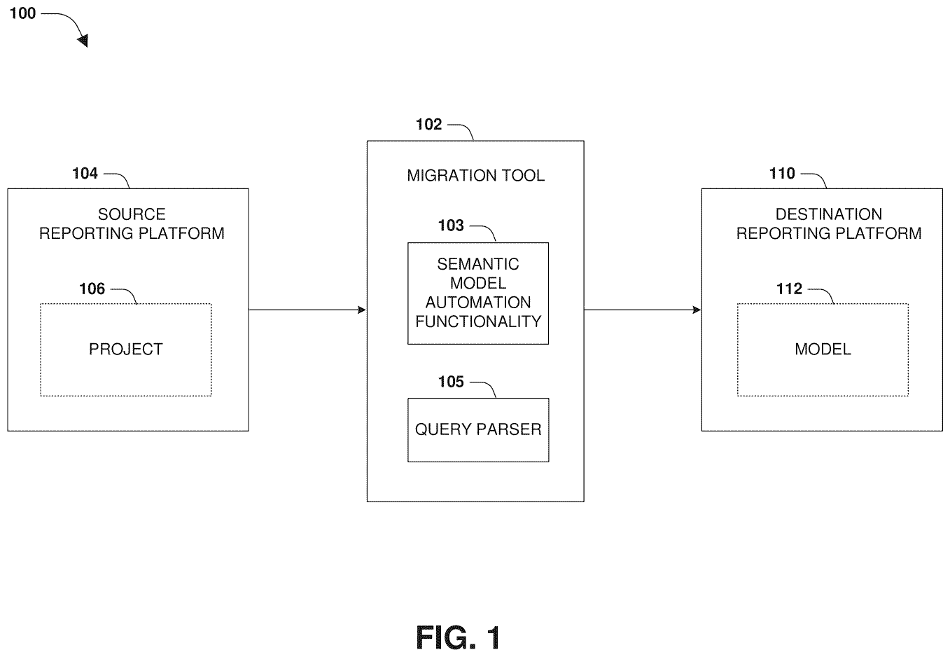

FIG. 1 is a block diagram illustrating an embodiment of a system 100 for implementing semantic model automation functionality for query parsing and transformation (e.g., SQL query parsing and transformation), where a project 106 is migrated from a source reporting platform 104 to a destination reporting platform 110 as a model 112 (e.g., a model having a .bim file). The source reporting platform 104 may provide access to operational data, along with tools that provide insight, analytics, and reporting for the operational data. The source reporting platform 104 may store data according to a proprietary format known to the source reporting platform 104 such that external services and applications are unable to readily access or understand the structure, organization, and relationships amongst the data. The source reporting platform 104 may store the data within complex data structures having intricate relationships and specific functions used to access the data, and thus the external services, applications, and platforms are unable easily retrieve the data without losing the structure, relationships, format, and meaning of the data. Because the source reporting platform 104 stores the data in the proprietary format, the data can be represented as a project that is accessible to users through the source reporting platform 104. The source reporting platform 104 provides users with business intelligence tools for the data, such as reporting tools, operational data analysis tools, cloud resource consumption reports, data presentations, interactive dashboards, ad hoc user queries, and/or other tools to organize, store, visualize, and interpret data.

An organization may want to migrate the data from the source reporting platform 104 to the destination reporting platform 110 such as for improved performance, utilization of features that the destination reporting platform 110 provides that the source reporting platform 104 does not provide, reduced costs, or other reasons. However, the source reporting platform 104 may store the data as a project 106 or any other proprietary format having specific structures (e.g., specific database structures/objects) and custom relationships created, managed, and known to the source reporting platform 104. That is, the source reporting platform 104 understands the columns and tables within which certain data is stored, relationships amongst the columns and tables, roles of users to access the data, views created for the data, functions and commands executed upon the data, security, formatting of the columns, names of the columns, which columns are hidden, calculated columns, conditions (e.g., join conditions or other conditions for merging or combining data or tables), filters for data, fields, etc. However, the destination reporting platform 110 does not have access to such information, and may utilize a different format such as a model 112 (e.g., a semantic model) to store and organize data.

Manual efforts to migrate the project 106 from the source reporting platform 104 to the destination reporting platform 110 as the model 112 is a complex and time consuming task that is error prone and can take multiple days to complete. To overcome these technical challenges, a migration tool 102 is provided to automate the migration of the project 106 from the source reporting platform 104 to the destination reporting platform 110 as a model 112. The automated migration is performed in a resource and time efficient manner (e.g., automated migration within half an hour, as opposed to manual migration that can take days).

The migration tool 102 implements semantic model automation functionality 103 and/or a query parser 105 for migrating the project 106. The query parser 105 is configured with custom code that parses text of a query used to access the project 106 through the source reporting platform 104. The query may include SQL statements of text that can be parsed by the query parser 105. The query parser 105 is capable of identifying strings of text that define tables, columns, structural information of how data is structured, functions used to access and manipulate the data, views created from the data, relationships amongst tables and columns, annotations, filters, calculated columns, expressions, and/or other components used by the source reporting platform 104 to store, maintain, format, and structure the data of the project 106 such as within a database. In this way, the migration tool 102 can identify the structure and format of how the source reporting platform 104 stores data of the project 106 within the database or other data storage.

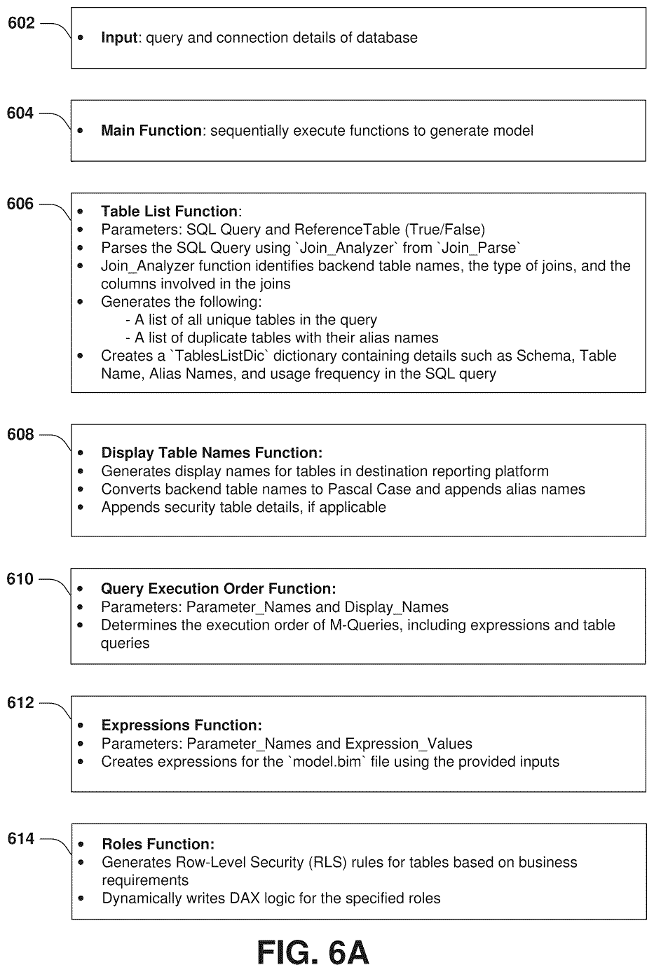

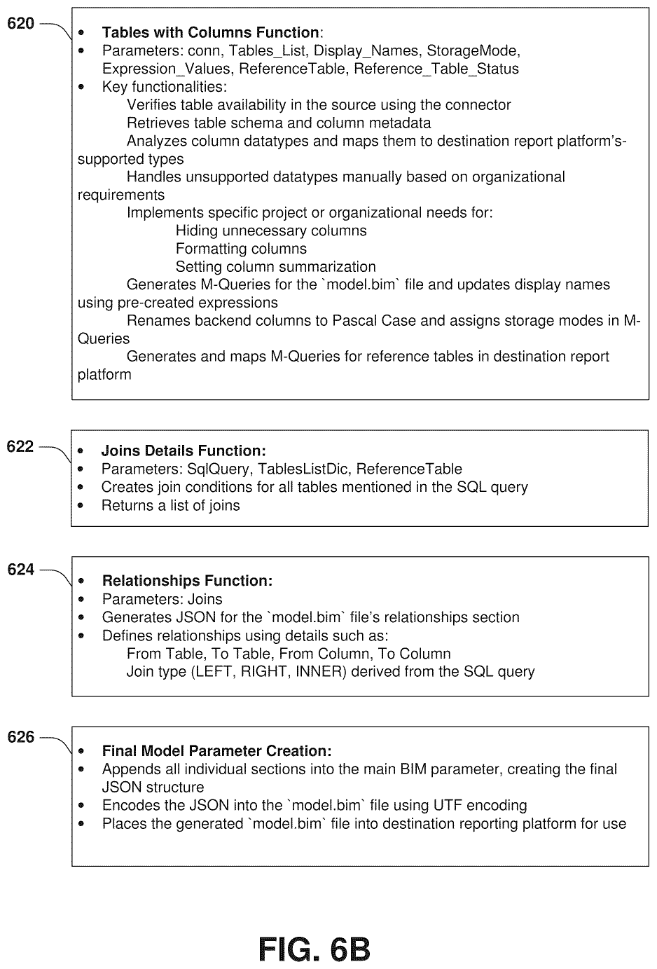

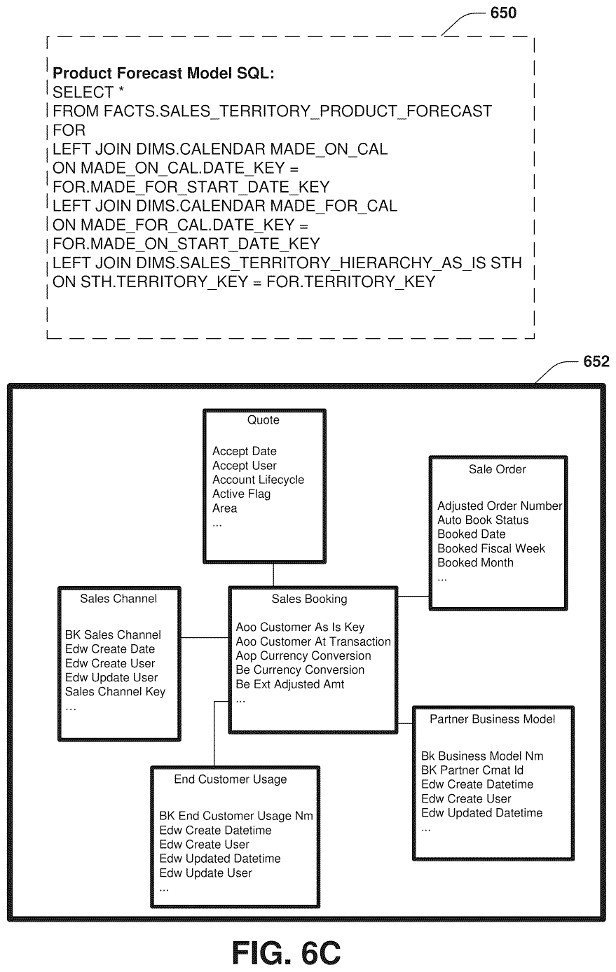

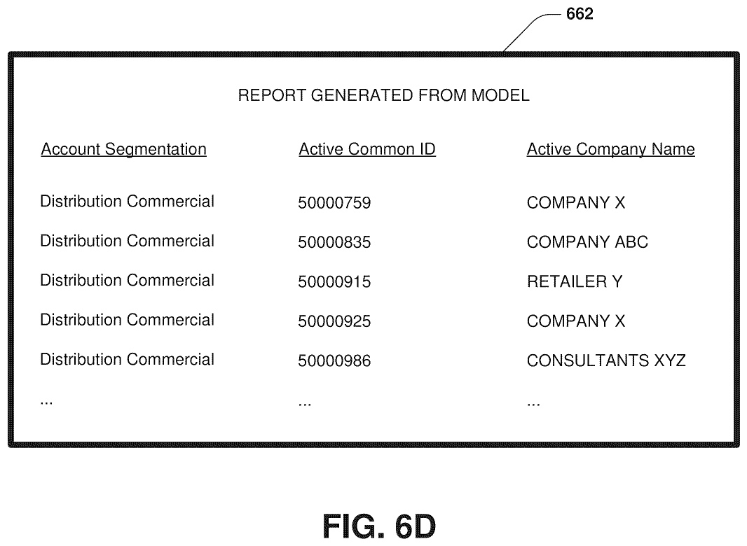

The semantic model automation functionality 103 may extract the components from the source reporting platform 104 for annotation and/or migration. In some embodiments, the semantic model automation functionality 103 may generate custom queries using text extracted as the components by the query parser 105 (e.g., generating an M-query embedded with parameters derived from the components). The custom queries are executed against the database used by the source reporting platform 104 to store data of the project 106. In this way, the semantic model automation functionality 103 can retrieve the components, such as tables, columns, and data for constructing the model 112. The semantic model automation functionality 103 executes various functions for constructing the model 112, which will be further described in relation to FIGS. 6A and 6B.

As part of executing functions for generating the model 112 for the destination reporting platform 110, the semantic model automation functionality 103 executes the functions to create a table list dictionary that includes details such as schema, table names, alias names, and usage frequency of the names in the query (e.g., a SQL query) parsed by the query parser 105 as the components. The semantic model automation functionality 103 generates display names for tables in the destination reporting platform 110, converts backend table names, appends alias names, and/or appends security table details. The semantic model automation functionality 103 determines an execution order for the custom queries (e.g., M-queries), which include expression queries and table queries. The semantic model automation functionality 103 creates expressions for the model 112 based upon parameter names and expression values extracted from the query.

As part of executing functions for generating the model 112 for the destination reporting platform 110, the semantic model automation functionality 103 creates security such as row-level security rules for tables based upon organizational security requirements and dynamically generates data analysis expression logic for specified roles. The data analysis expression logic includes formulas such as functions, operations, and values used to perform calculations and queries on data in related tables and columns in tabular data models. The semantic model automation functionality 103 verifies source table availability, retrieves table schema and column metadata, and analyzes column data types and maps the column data types to types supported by the destination reporting platform 110. The semantic model automation functionality 103 handles unsupported data types, implements specific project or organization requirements (e.g., hiding columns, formatting columns, or setting column summarizations), generates the custom queries for the model 112, updates display names using pre-created expressions, renames backend columns and assigns storage modes, and generates and maps the custom queries to references tables in the destination reporting platform 110. The semantic model automation functionality 103 creates conditions for tables mentioned by the query (e.g., join conditions or other conditions for combining/merging tables). The semantic model automation functionality 103 generates relationships, which may be specified through JSON within a file relationship section in the model 112. In this way, the semantic model automation functionality 103 executes various functions to generate outputs used to construct the model 112.

In some embodiments, the semantic model automation functionality 103 appends outputs from the functions into a main model parameter (a main Building Information Model (BIM) parameter) to create a JSON structure. In some embodiments, the semantic model automation functionality 103 encodes the JSON structure into the model 112 (the . bim file) using an encoding system (e.g., a Unicode Transformation Format (UTF) encoding). The generated model 112 is loaded into the destination reporting platform 110 to use, such as to provide a user with access to reports, ad hoc user queries, operational intelligence, operational data, data analytics, and/or other tools and information. In this way, the migration tool 102 migrates the project 106, having a format and structure specific to the source reporting platform 104 (e.g., a format and structure unknown to or not natively understood or supported by the destination reporting platform 110), to the destination reporting platform 110 as the model 112 having a format and structure supported by the destination reporting platform 110.

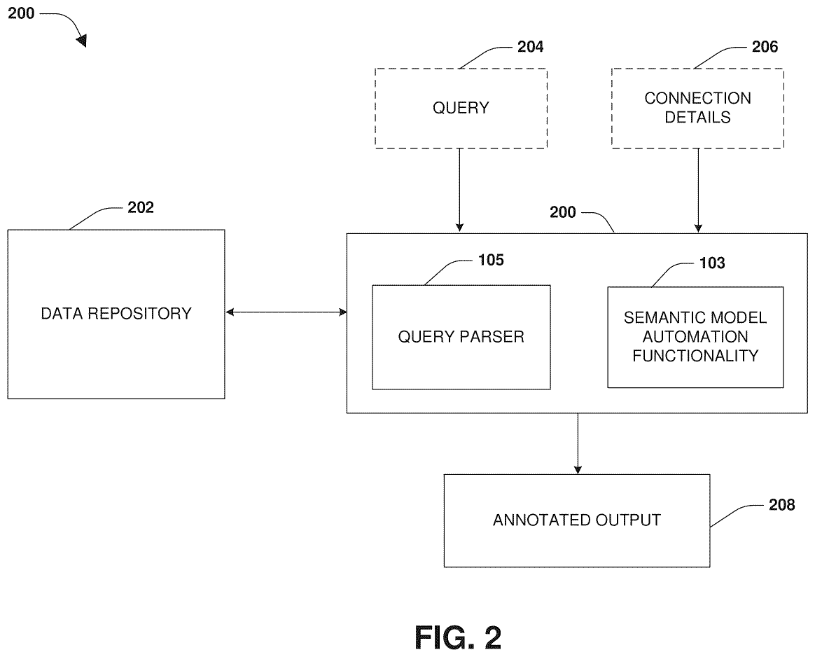

FIG. 2 is a block diagram illustrating an embodiment of a system 200 for implementing the semantic model automation functionality 103 for query parsing and transformation. The system 200 may receive a query 204 and connection details 206 for a data repository 202, such as a cloud data warehouse platform used to store data according to a first format and structure. The system 200 may utilize the connection details 206 to establish and verify a connection with the data repository 202. The system 200 implements the query parser 105 for parsing the query 204 to identify components used to structure, format, and store the data within the data repository 202. The query parser 105 and/or the semantic model automation functionality 103 are used to generate custom queries targeting the data repository 202 based upon the components parsed from the query 204. The semantic model automation functionality 103 may determine an order in which to execute the custom queries for extracting the data and/or metadata for the data. The extracted data and/or metadata can be used for various purposes such as annotating the data with information, restructuring or reformatting the data, migrating the data between different applications, services, or platforms, etc. In some embodiments, the custom queries are executed against the data repository 202 to generate a query output that is parsed and annotated with additional information as annotated output 208. The annotated output 208 may be annotated with additional information different than the data and/or metadata within the data repository 202. The annotated output 208 may include the data, metadata, and/or additional information, which may be used for various use cases such as making the annotated output 208 compatible with a service, application, or platform.

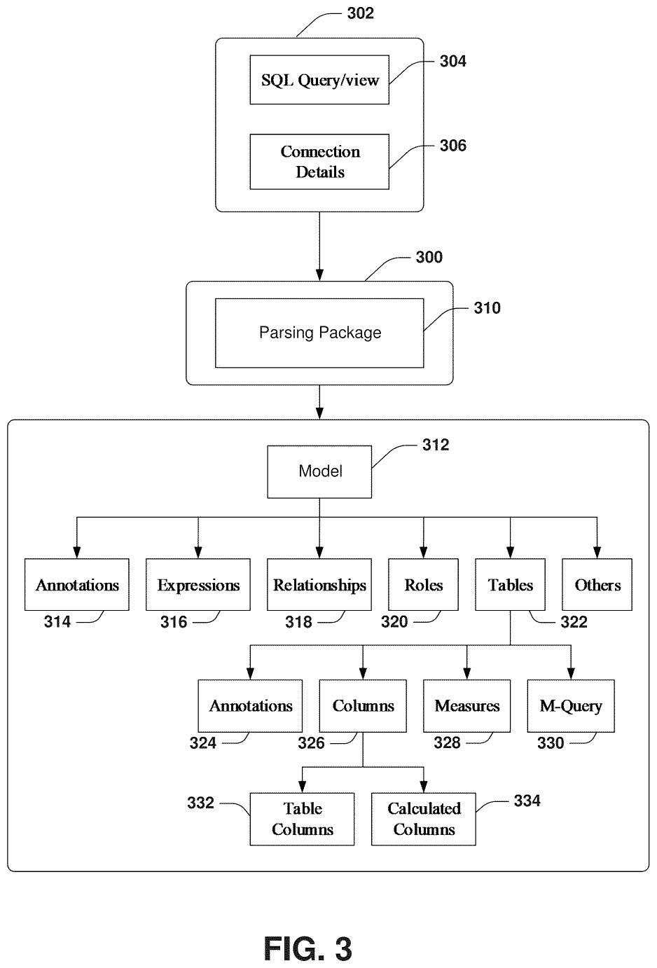

FIG. 3 is a block diagram illustrating an embodiment of a system 300 for implementing the semantic model automation functionality for query parsing and transformation, where a query such as a SQL query 304 is transformed into a model 312. The system 300 may receive an input 302 that includes the SQL query 304 (a query/view) and connection details 306 to connect to a data repository storing data targeted by the SQL query 304. The system 300 includes a query parser that parses the SQL query 304 to extract components used to store the data within the data repository. The components are used by the system 300 to generate a parsing package 310 of custom queries that are executed against the data repository to extract the data and/or metadata for the data. The system 300 includes the semantic model automation functionality 103 that uses the parsing package 310, the data, and/or the metadata to generate the model 312.

As part of constructing a first level of a hierarchical structure created as part of the model 312, the semantic model automation functionality 103 generates annotations 314 for inclusion within the model 312 to annotate the data, extracted from the data repository, with additional information. The annotations 314 may annotate a query output of the SQL query 304 with additional information so that the query output (e.g., data extracted by the semantic model automation functionality 103 from the data repository) can be used for by various services, applications, and/or platforms. The semantic model automation functionality 103 generates expressions 316 for the data to include within the model 312. The semantic model automation functionality 103 generates relationships 318 amongst data, tables, and/or columns for inclusion within the model 312. The semantic model automation functionality 103 generates roles 320 for inclusion within the model 312. The roles 320 may define permissions that allow users to perform specific tasks. The semantic model automation functionality 103 generates tables 322 for inclusion within the model 312. The tables 322 may be generated based upon tables within the data repository used to store the data. Some tables may mirror the original structure of the tables within the data repository. Some tables may have a different structure, name, etc. Some tables may be hidden based upon certain requirements such as where key columns are hidden.

As part of constructing a second level of the hierarchical structure created as part of the model 312, the semantic model automation functionality 103 generates annotations 324 for inclusion within the model 312. The annotations 324 may annotate a query output of the SQL query 304 with additional information so that the query output (e.g., data extracted by the semantic model automation functionality 103 from the data repository) can be used for by various services, applications, and/or platforms. The semantic model automation functionality 103 generates columns 326 for inclusion within the model 312 to store data extracted from the data repository. The semantic model automation functionality 103 generates measures 328 for inclusion within the model 312. The measures 328 may relate to aggregations performed within a SQL group by a SQL statement (e.g., an aggregation of data values, such as sum, count, minimum, maximum, average, etc.). The measures 328 may relate to a column that attaches a calculation to a table. The semantic model automation functionality 103 generates custom queries 330 such as M-Queries that can be used to as a data query capable of combining and/or transforming data from various sources (e.g., filter, combine, and mashup data from one or more data sources).

As part of constructing a third level of the hierarchical structure created as part of the model 312, the semantic model automation functionality 103 generates table columns 332 for inclusion within the model 312. Data from the data repository may be populated into the table columns 332. The semantic model automation functionality 103 generates calculated columns 334 for inclusion within the model 312. The calculated columns 334 may relate to a field in a table that adds data using a formula, such as to combine text values from different columns, calculate numeric values from other values, create a fixed value for a row, add a text value for rows, etc. In this way, query output from the SQL query 304 is parsed, annotated, and/or transformed into the model 312 or some other data structure or format that can be used by various services, applications, and/or platforms.

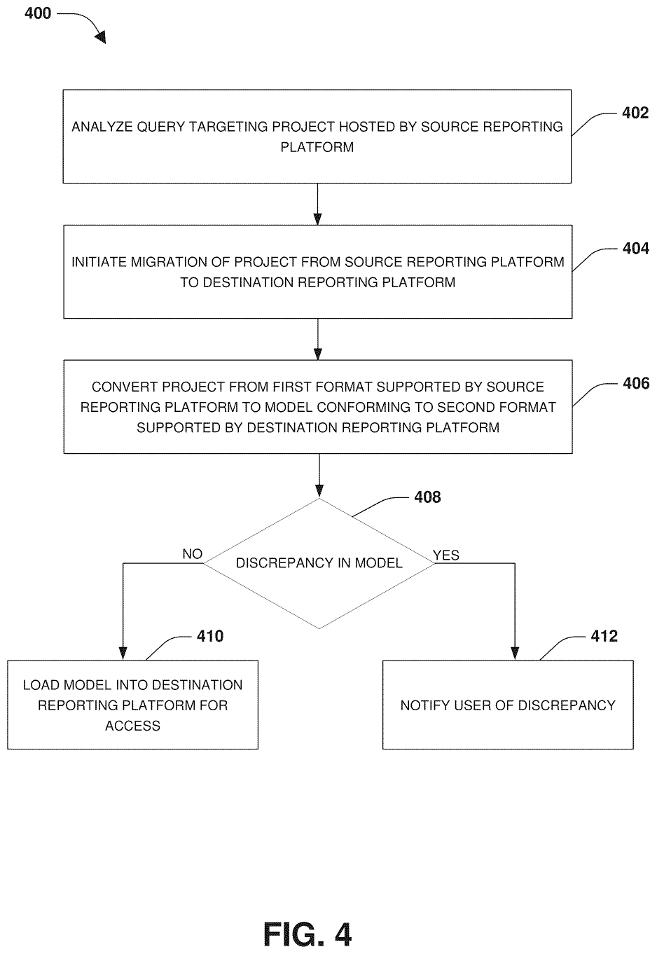

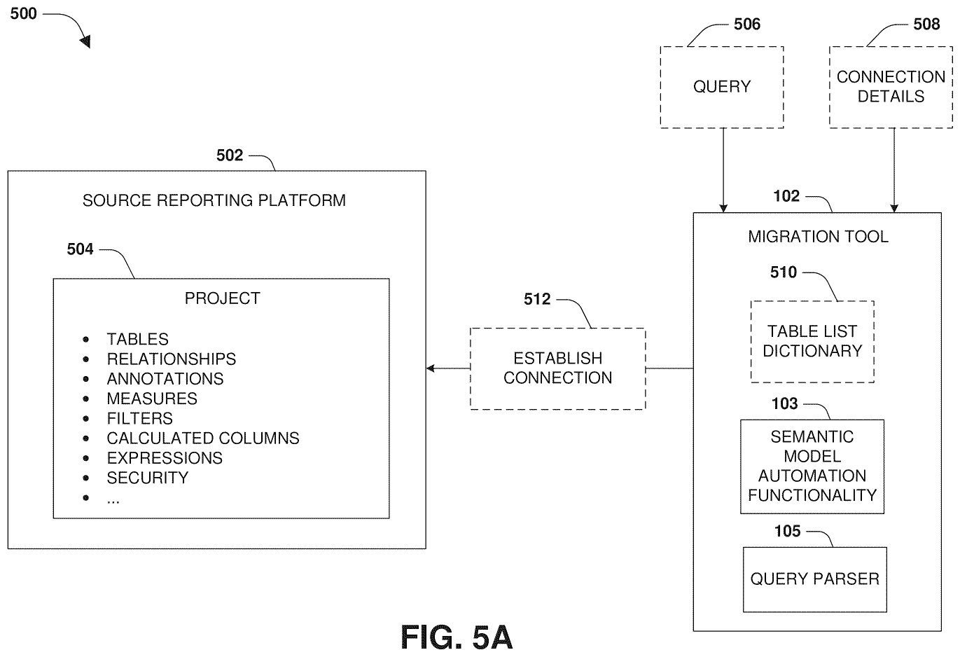

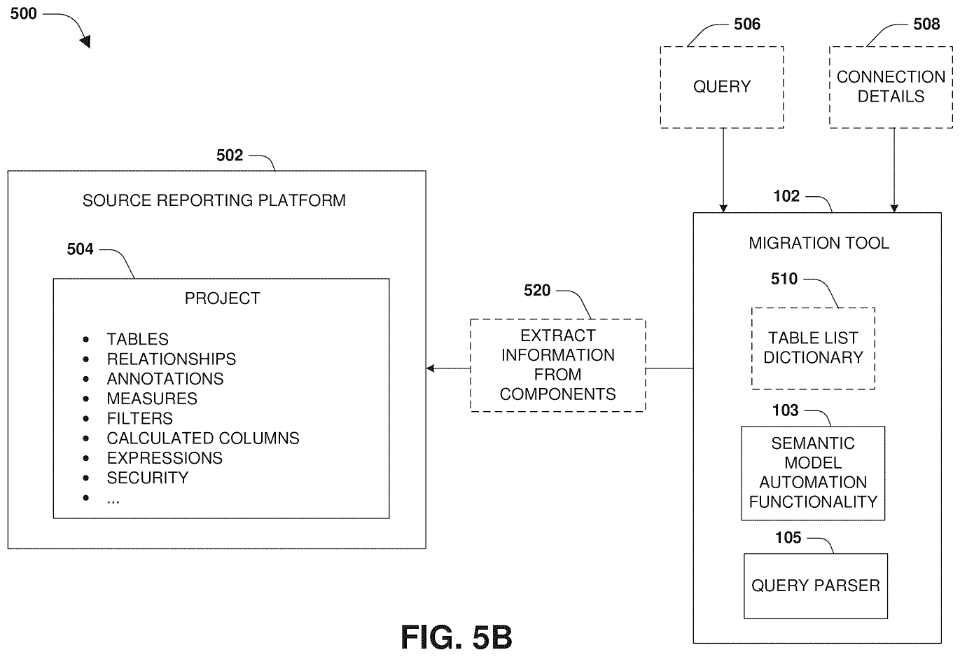

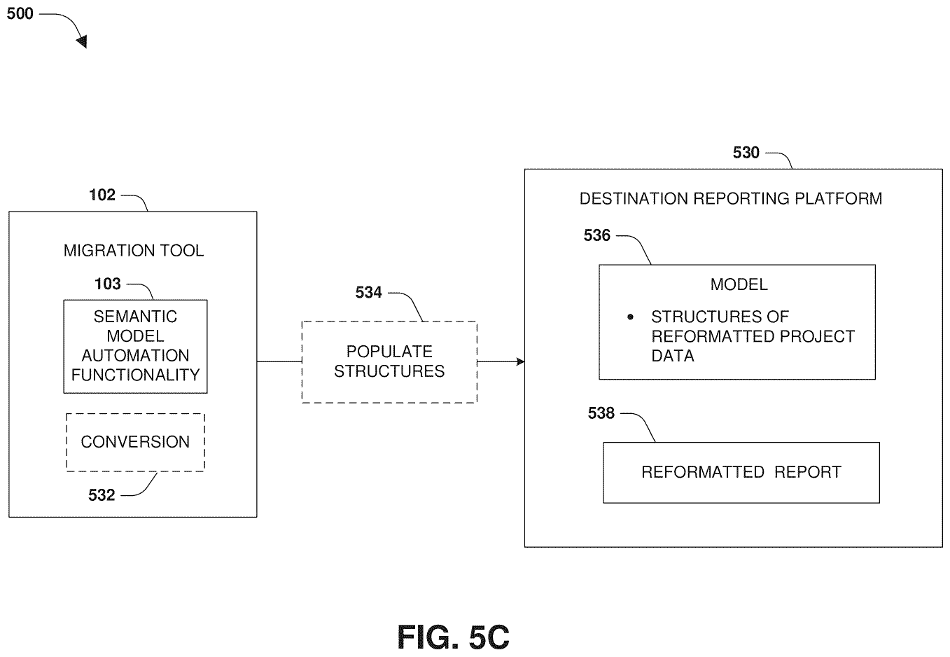

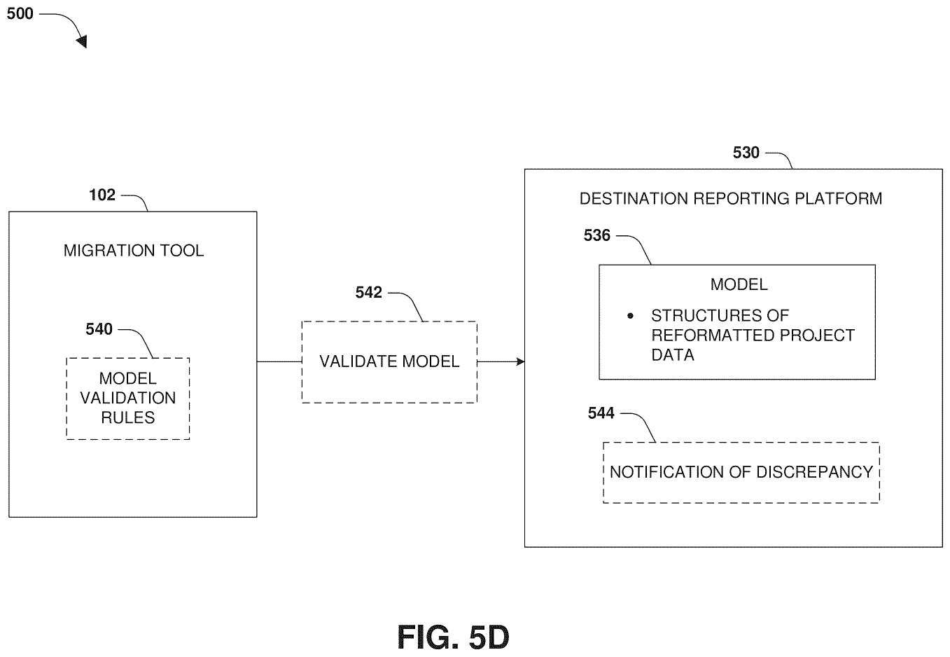

FIG. 4 is a flow chart illustrating an embodiment of a method 400 for implementing semantic model automation functionality 103 for query parsing and transformation, which is further described in conjunction with system 500 FIGS. 5A-5D. A source reporting platform 502 may store and maintain data as a project 504, as illustrated by FIG. 5A. The data may be stored within tables of a database. The project 504 may structure, format, and organize the data according to a first format that may be proprietary to the source reporting platform 502 and specifically tailored to how the source reporting platform 502 stores and organizes the data for a user/organization in order to provide tools for the data, such as reporting and business insight and analytics tools. The project 504 may include various components (structural elements) such as tables, relationships, annotations, measures, filters, calculated columns, expressions, security, etc. A query 506 may be defined for accessing the data of the project 504.

The migration tool 102 may receive a request to migrate the project 504 from the source reporting platform 502 to a destination reporting platform 530 as a model 536. The migration tool 102 may receive the query 506 and connection details 508. The migration tool 102 may establish 512 a connection to a data source used by the source reporting platform 502 to store the data of the project 504. The connection is established for extracting information from or about the components (structural elements) of the project 504. The migration tool 102 may implement the query parser 105 to analyze the query 506, during operation 402 of method 400. In particular, the query parser 105 parses text of the query 506 to identify the components used by the source reporting platform 502 to organize, format, and structure the data of the project 504. The parsed text may be used to generate parameters for extracting data from the components of the project 504 such as from tables and columns. The query parser 105 may dynamically generate the parameters that are used to construct custom queries. The custom queries can be executed against the database for accessing and retrieving information from the components.

During operation 404 of method 400, the migration tool 102 implements migration of the project 504 from the source reporting platform 502 to the destination reporting platform 530 as the model 536. Because the project 504 is formatted and structured according to the first format (may also be referred to as a source reporting platform format), the semantic model automation functionality 103 is implemented to convert the project 504 into a second format (may also be referred to as a destination reporting platform format) different from the first format, which is compatible with the destination reporting platform 530, during operation 406 of method 400. As part of the conversion, the migration tool 102 extracts 520 information from the components used by the source reporting platform 502 to organize, structure, and format the project 504, as illustrated by FIG. 5B. The extracted information may include data (e.g., operational data organized as part of the project 504, and provided by the source reporting platform 502 through reports, user interfaces, operational analytic tools, etc.), the tables, the relationships, the annotations, the measures, the filters, the calculated columns, the expressions, security, etc.

The semantic model automation functionality 103 uses the extracted information to generate a table list dictionary 510 of the tables used to store data of the project 504. The table list dictionary 510 may include a schema for the tables (e.g., a database schema used to organize the data into the tables), table names of the tables, and usage frequency of the table names within the query 506. The semantic model automation functionality 103 generates display names for the tables as part of converting the project 504 into the model 536. The semantic model automation functionality 103 may determine an execution order for executing one or more custom queries for migrating the project 504 from the source reporting platform 502 to the destination reporting platform 530 as the model 536. The custom queries may include expression and table queries. The custom queries are executed as part of a conversion process 532 that converts query output of the custom queries into annotated information, as such for inclusion within the model 536, as illustrated by FIG. 5C.

As part of the conversion process 532, the semantic model automation functionality 103 generates various structures for the model 536, and populates 534 the structures with reformatted project data extracted from the source reporting platform 502. In some embodiments, the semantic model automation functionality 103 generates code that is populated into the model 536 to define relationships amongst tables and/or columns that were extracted as the components from the project 504. The code may be used to create the tables, the columns, and implement the relationships within the model 536 according to the second format (the destination reporting platform format) supported by the destination reporting platform 530. In some embodiments, semantic model automation functionality 103 generates or modifies code that is populated into the model 536 to implement security through the destination reporting platform 530 for the model 536. The security may relate to security requirements of an organization and/or security that was implemented by the source reporting platform 502 for data within tables of the project 504. In some embodiments, the security is defined by appending security table details to the model 536. In some embodiments, row level security rules are generated for the tables (structures) created within the model 536 based upon the security requirements.

In some embodiments, the semantic model automation functionality 103 generates code that is populated into the model 536 to create roles that were extracted as the components from the project 504. The roles may be implemented to provide specific access to the data within the model 536 and/or for performing various operations defined by the roles. In some embodiments, data analysis expression logic is generated for specified roles for the model 536. The data analysis expression logic may be a language supported by the destination reporting platform 530 (e.g., PowerBI). The data analysis expression logic includes formulas such as functions, operations, and values used to perform calculations and queries on data in related tables and columns in tabular data models such as model 536.

In some embodiments, the semantic model automation functionality 103 reformats columns within tables that were extracted from the project 504. The columns are recreated for the model 536 according to the second format supported by the destination reporting platform 530, thus creating reformatted columns within the model 536. Data, extracted from the columns of the tables within the project 504, is reformatted to a format of the reformatted columns as reformatted data. The reformatted data is populated into the reformatted columns.

In some embodiments, the semantic model automation functionality 103 determines that a column within a table, extracted from the project 504 and recreated for the model 536 according to the second format, had a hidden attribute to hide the column from end users. Accordingly, the semantic model automation functionality 103 recreates the column within the model 536 as a recreated column to comprise the data migrated from the column within the table extracted from the project 504. The hidden attribute is applied to the recreated column within the model 536. In some embodiments, the semantic model automation functionality 103 extracts a column from the source reporting platform 502 as an extracted column for inclusion within the model 536. The semantic model automation functionality 103 applies a hidden attribute to the extracted column based upon a determination that the column had a column type that is to be hidden from end users (e.g., a backend system or key column).

In some embodiments, the semantic model automation functionality 103 extracts expressions from the project 504 for inclusion within the model 536. The semantic model automation functionality 103 generates and utilizes code to recreate the expressions in the model 536 according to the second format. An expression may be a SQL expression that combines one or more values, operators, and/or functions that are all evaluated to a value. In this way, expressions are created for the model 536.

In some embodiments, the semantic model automation functionality 103 extracts annotations from the source reporting platform 104 for inclusion within the model 536. The semantic model automation functionality 103 generates and utilizes code to recreate the annotations in the model 536 according to the second format. In some embodiments, query output is parsed and annotated, such as for inclusion within the model 536. In this way, annotations are created for the model 536.

In some embodiments, the semantic model automation functionality 103 extracts measures from the source reporting platform 104 for inclusion within the model 536. The semantic model automation functionality 103 generates and utilizes code to recreate the measures in the model 536 according to the second format. The measures may relate to aggregations performed within a SQL group by a SQL statement (e.g., an aggregation of data values, such as sum, count, minimum, maximum, average, etc.). The measures may relate to a column that attaches a calculation to a table. In this way, measures are created for the model 536.

In some embodiments, the semantic model automation functionality 103 extracts filters from the source reporting platform 104 for inclusion within the model 536. The semantic model automation functionality 103 generates and utilizes code to recreate the filters in the model 536 according to the second format. The filters are used as modifiers on a function such as an aggregate function to limit values used in an aggregation. In this way, filters are created for the model 536.

In some embodiments, the semantic model automation functionality 103 extracts calculated columns from the source reporting platform 104 for inclusion within the model 536. The semantic model automation functionality 103 generates and utilizes code to recreate the calculated columns in the model 536 according to the second format. The calculated columns may relate to a field in a table that adds data using a formula, such as to combine text values from different columns, calculate numeric values from other values, create a fixed value for a row, add a text value for rows, etc. In this way, calculated columns are created for the model 536.

In some embodiments, the semantic model automation functionality 103 extracts a column from the source reporting platform 104 for inclusion within the model 536. The semantic model automation functionality 103 reconstructs the column according to the second format to create a reconstructed column within the model 536. The reconstructed column may be renamed to a name different than the column extracted from the source reporting platform 104 so that the reconstructed column conforms to the second format. In some embodiments, the semantic model automation functionality 103 utilizes a data structure (e.g., a spreadsheet, a document, a file, etc.) to rename a batch of reconstructed columns. The data structure may map original names of the columns to new names for the corresponding reconstructed columns. In some embodiments, the semantic model automation functionality 103 converts backend table names for the model 536, and appends alias names to the model 536 for the backend table names. In some embodiments, the semantic model automation functionality 103 is configured to analyze, reformat, and map columns of tables to types supported by the second format.

In some embodiments, the semantic model automation functionality 103 generates code that is populated into the model 536 to generate conditions for creating relationships amongst tables for inclusion within the model 536 (e.g., join conditions or other types of conditions). The code is utilized for recreating the tables in the model 536, and implementing the relationships for the tables.

The migration tool 102 may migrate reports and/or other visuals from the source reporting platform 502 to the destination reporting platform 530. For example, the migration tool 102 extracts a report from the source reporting platform 502. The report may be formatted according the first format (the source reporting platform format). The migration tool 102 converts the report into the second format (the destination reporting platform format) as a reformatted report 538 that is migrated into the destination reporting platform 530. The reformatted report 538 may include visuals and/or a layout similar to that of the report, but is converted into the second format that can be loaded, manipulated, and/or displayed through the destination reporting platform 530. In this way, the model 536 and/or the reformatted report 538 are loaded into the destination reporting platform 530.

During operation 408 of method 400, the migration tool 102 validates 542 the model 536 using model validation rules 540 to determine whether there is a discrepancy, as illustrated by FIG. 5D. The model validation rules 540 may be generated based project standards for the project 504 (e.g., an organization may define standards for projects). In this way, the model validation rules 540 are applied to the model 536 to determine whether the model 536 adheres to the project standards (e.g., whether a column that is supposed to be hidden is actually hidden within the model 536; whether a role was granted access permitted by the organization or was granted too much access; etc.). If no discrepancy is detected because the model validation rules 540 were used to determine that the model 536 adheres to the project standards, then the model 536 is loaded into the destination reporting platform 530 for user access, during operation 410 of method 400. If a discrepancy is detected because the model validation rules 540 were used to determine that the model 536 did not adhere to the project standards, then a notification 544 of the discrepancy is provided, during operation 412 of method 400. The notification may describe what model validation rules and/or project standards were violated and/or how to fix the discrepancies.

Once the model 536 is validated and loaded into the destination reporting platform 530, the model 536 is used to provide users with access to the data previously represented as the project 504 through the source reporting platform 502. The user may utilize operational analytic and reporting tools provided by the destination reporting platform 530 to access the data stored by the model 536, such as to create reports that include visuals and layouts supported by the destination reporting platform 530.

FIGS. 6A-6B illustrate examples of functions implemented by the semantic model automation functionality 103. The semantic model automation functionality 103 takes an input 602 that may include a query and/or connection details of a database targeted by the query. The semantic model automation functionality 103 may implement a main function 604 that sequentially executes functions 606-624 to create a model (e.g., a parsed and annotated query output). The semantic model automation functionality 103 may implement a table list function 606. The table list function 606 takes the query and/or a reference table of true/false values as parameters. The table list function 606 parses the query using a join analyzer function from a join parse command. The join analyzer function identifies backend table names, types of joins, and columns involved in the joins. The table list function 606 generates a list of unique tables in the query and a list of duplicate tables with their alias names. The table list function 606 creates a table list dictionary containing details such as schema, table name, alias names, and usage frequency in the query.

The semantic model automation functionality 103 may implement a display table names function 608. The display table names function 608 generates display names for tables in a destination reporting platform. The display table names function 608 converts backend table names (e.g., converts the names to Pascal Case) and appends alias names. The display table names function 608 appends security table details, if applicable.

The semantic model automation functionality 103 may implement a query execution order function 610. The query execution order function 610 takes parameters such as parameter names and display names as input. The query execution order function 610 determines an execution order of custom queries (e.g., M-Queries), including expressions and table queries.

The semantic model automation functionality 103 may implement an expressions function 612. The expressions function 612 may take parameters such as parameter names and expression values as input. The expressions function 612 may create expressions for the model (e.g., a model. bim file) using the parameters as input.

The semantic model automation functionality 103 may implement a roles function 614. The roles function 614 may generate Row-Level Security (RLS) rules for tables based upon organizational requirements. The roles function 614 may dynamically write Data Analysis expression (DAX) logic for specified roles.

The semantic model automation functionality 103 may implement a tables with columns function 620. The tables with columns function 620 takes parameters such as connection, table lists, display names, storage mode, expression values, reference table, and reference table status as inputs. The tables with columns function 620 performs functions such as verifying table availability at a source using the connector, retrieving table schema and column metadata, analyzing column data types, mapping the column data types to types supported by the destination reporting platform, and/or handling unsupported data types based on organizational requirements. The tables with columns function 620 implements functions related to a project or organizational requirements, such as hiding unnecessary columns, formatting columns, and/or setting column summarizations. The tables with columns function 620 implements functions that generate custom queries (e.g., M-Queries) for the model (e.g., a model. bim file) and updates display names using pre-created expressions. The tables with columns function 620 implements functions that rename backend columns such as to Pascal Case, and assigns storage modes in the custom queries. The tables with columns function 620 implements functions that generate and map the custom queries to reference tables in the destination reporting platform.

The semantic model automation functionality 103 may implement a join details function 622. The join details function 622 takes parameters such as the query, the table list dictionary, and/or a reference table as inputs. The join details function 622 creates conditions (e.g., join conditions or other types of conditions for merging/combing data from tables) for tables referenced in the query such as the reference table, and returns a list of joins.

The semantic model automation functionality 103 may implement a relationships function 624. The relationships function 624 takes parameters such as the list of joins as input, and generates JSON data for a relationship section within the model. The relationships function 624 defines relationships using details such as: “From Table, To Table, From Column, To Column Join type (LEFT, RIGHT, INNER)” derived from the query.

The semantic model automation functionality 103 may implement a final model parameter creation function 626 that appends outputs from functions 606-624 into the model, such as into a main BIM parameter to create a JSON structure. The JSON structure is encoded into the model using an encoding technique such as UTF encoding. The final model parameter creation function 626 loads the model into the destination reporting platform for use.

FIG. 6C illustrates an example of a query 650 (e.g., a SQL query or other type of query) that is transformed into a model. The query parser 105 receives and parses the query 650 that may target a product forecast model. The query parser 105 may parse the query 650 to identify tables, joins, and/or other components used to store data, such as operational data of a project hosted by an application, service, or platform. In some embodiments, an output of the query 650 may be parsed and annotated to generate an annotated output provided through a user interface 652. In some embodiments, the annotated output may relate to a model that is built by transforming a project targeted by the query 650 into the model. The model may include tables that are provided through the user interface 652, such as a quote table, a sale order table, a sales booking table, an end customer usage table, etc. In this way, data targeted by the query 650 (e.g., data of the project) may be converted from a first format to a second format (e.g., converting into the model) that is compatible with an application, service, or platform hosting the user interface 652.

FIG. 6D illustrates an example of a report 662 generated using information stored within a model generated by the semantic model automation functionality 103. The migration tool 102 may have transformed, restructured, and reformatted a project from a native format of a first application, service, or platform into a different format supported by a second application, service, or platform that may otherwise not have access to the project or the ability to interpret the project. The first application, service, or platform may generate reports for the project. The migration tool 102 may migrate the reports to the second application service, or platform. Accordingly, the report 662 may be a migrated report. The migrated report may have been created from a report that was transformed, restructured, and reformatted to be compatible with the model and/or the second application, service, or platform.

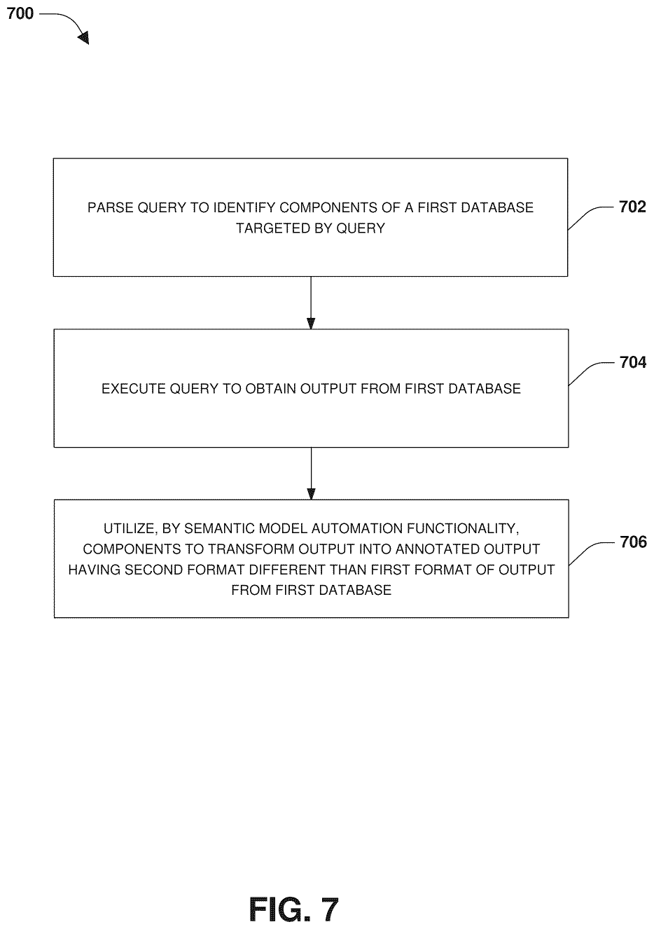

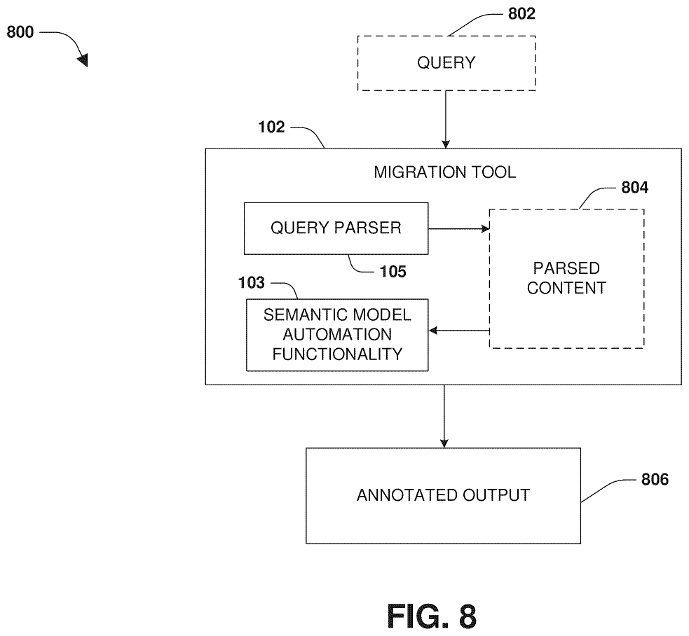

FIG. 7 is a flow chart illustrating an embodiment of a method 700 for implementing the semantic model automation functionality 103 for query parsing and transformation, which is described in conjunction with system 800 of FIG. 8. A migration tool 102 may access or receive a query 802 (a SQL query) targeting a first database. During operation 702 of method 700, the migration tool 102 may implement the query parser 105 to parse the query 802 to identify components of the first database targeted by the query 802. The components may include tables, relationships, annotations, measures, filters, calculated columns, expressions, etc. In this way, the components may be parsed as parsed content 804 that is input into the semantic model automation functionality 103 implemented by the migration tool 102.

During operation 704 of method 700, a query is executed to obtain an output from the first database. In some embodiments, the executed query is the query 802 parsed by the query parser 105. In some embodiments, the executed query is a new query (a custom query) constructed using the components and/or constructed based upon how a query output is to be annotated. The query output from the first database may have a first format (e.g., certain data, annotations, etc.).

During operation 706 of method 700, the semantic model automation functionality 103 utilizes the components to transform the query output into an annotated output 806 having a second format different than the first format of the query output (e.g., different data, different annotations, etc.). In some embodiments, the query output is transformed into the annotated output 806 that is used to populate a second database, application, service, or platform supporting the second format different than the first format. In some embodiments, the second database, the application, the service, or the platform does not support the first format.

In some embodiments, the semantic model automation functionality 103 creates a table list dictionary that includes a schema, table names of the tables, and/or usage frequency of the table names within the query 802, which may be used to generate the annotated output 806. The semantic model automation functionality 103 generates display names for a table, which may be used to generate the annotated output 806. The semantic model automation functionality 103 may determine an execution order of custom queries to perform as part of obtaining the query output. The custom queries may include expressions and table queries. The semantic model automation functionality 103 may execute the custom queries according to the execution order to obtain the query output. The table list dictionary and/or the display names may be used to transform the query output into the annotated output 806.

In some embodiments, the semantic model automation functionality 103 creates security table details, expressions, row level security rules, roles, data analysis expression logic for the roles, relationships between tables and columns referenced by the query, and/or conditions for the tables (e.g., join conditions), which may be used to transform the query output into the annotated output 806. In some embodiments, the semantic model automation functionality 103 converts backend table names and appends alias names of tables referenced by the query 802, which may be used to transform the query output into the annotated output 806. In some embodiments, the semantic model automation functionality 103 may analyze, reformat, and/or map columns of the tables referenced by the query 802 to types supported by the second format, which may be used to transform the query output into the annotated output 806. In this way, the migration tool 102 parses and annotates the query output to create the annotated output 806.

In some embodiments, a method is provided. The method includes analyzing a query targeting a project hosted by a source reporting platform to identify one or more components of the source reporting platform used to host the project, the source reporting platform using a first format to represent the project as a model; to migrate the model from the source reporting platform to a destination reporting platform, transforming the model from the first format to a second format used by the destination reporting platform by: extracting data from the one or more components within the source reporting platform, and using the extracted data for creating and populating structures within the model conforming to the second format, the second format being different from the first format; and loading the model into the destination reporting platform to provide access to the project migrated from the source reporting platform to the destination reporting platform.

In some embodiments, the method comprises extracting a report from the source reporting platform, wherein the report is formatted according to the first format; converting the report to the second format as a reformatted report; and migrating the reformatted report into the destination reporting platform, wherein the reformatted report includes a layout of the report.

In some embodiments, the method comprises generating one or more model validation rules based upon a first format defined project standard; and applying the one or more model validation rules to the model to determine whether the model adheres to the project standard.

In some embodiments, the method comprises in response to detecting a discrepancy between the model and the one or more model validation rules, providing a notification of the discrepancy to a user.

In some embodiments, the method comprises generating code for inclusion within the model to include one or more relationships amongst tables extracted as the components from the project; and utilizing the code to recreate the tables in the model and implementing the relationships for the tables.

In some embodiments, the method comprises modifying code of the model to implement security provided by the project for data stored within tables maintained by the source reporting platform.

In some embodiments, the method comprises generating code for inclusion within the model to include roles extracted as the components from the project; and utilizing the code to implement the roles for accessing data within the model.

In some embodiments, a computing device is provided. The computing device comprises a memory comprising machine executable code; and a processor coupled to the memory, the processor configured to parse a query to identify one or more components used by a source reporting platform to host a project in a first format; construct one or more custom queries based upon the one or more components to target a data repository storing the project; execute the one or more custom queries against the data repository to extract data and metadata of the project from the components used by the source reporting platform to format the project; create a model conforming to a second format supported by a destination reporting platform using the data and metadata extracted from the source reporting platform; and load the model into the destination reporting platform to provide access to the project migrated as the model from the source reporting platform to the destination reporting platform.

In some embodiments, the machine executable code causes the computing device to reformat a column within a table extracted as a component from the first format to create a reformatted column within the model.

In some embodiments, the machine executable code causes the computing device to determine that a column within a table extracted as a component from the source reporting platform had a hidden attribute to hide the column from one or more end users; recreate the column within the model as a recreated column to comprise data migrated from the column within the table extracted from the source reporting platform; and apply the hidden attribute to the recreated column.

In some embodiments, the machine executable code causes the computing device to extract an expression as a component from the source reporting platform; and generate and utilize code to recreate the expression in the model according to the second format.

In some embodiments, the machine executable code causes the computing device to create a table list dictionary including a schema, table names of tables used to store the data and metadata of the project, and usage frequency of the table names within the query; and utilize the table list dictionary to extract the data and metadata.

In some embodiments, the machine executable code causes the computing device to extract annotations as the one or more components from the source reporting platform; and generate and utilize code to recreate the annotations in the model according to the second format.

In some embodiments, the machine executable code causes the computing device to extract at least one of measures, filters, or calculated columns as the components from the source reporting platform; and generate and utilize code to recreate the components in the model according to the second format.

In some embodiments, the machine executable code causes the computing device to analyze, reformat, and map columns of tables referenced by the query to types supported by the second format for inclusion within the model.

In some embodiments, the machine executable code causes the computing device to dynamically generate one or more parameters for extracting the data from the one or more components, wherein the one or more parameters are dynamically generated by a query parser that parses a query targeting the source reporting platform; construct a custom query using the one or more parameters; and execute the custom query against the source reporting platform to access the data and metadata from the one or more components.

In some embodiments, a non-transitory machine readable medium is provided. The non-transitory machine readable medium comprises instructions, which when executed by a machine, causes the machine to identify one or more components used by a source reporting platform to host a project formatted according to a first format; extract data from the one or more components within the source reporting platform; create a model conforming to a second format of a destination reporting platform using the data extracted from the source reporting platform; and load the model into the destination reporting platform to provide access to the project migrated as the model from the source reporting platform to the destination reporting platform.

In some embodiments, the instructions cause the machine to extract a column as a component from the source reporting platform; reconstruct the column according to the second format to create a reconstructed column within the model; and rename the reconstructed column to differ from a name of the column within the source reporting platform.

In some embodiments, the instructions cause the machine to create at least one of security table details, expressions, or row level security rules for the model.

In some embodiments, the instructions cause the machine to create at least one of roles, data analysis expression logic for the roles, or relationships between tables and columns referenced by the query for the model.

In some embodiments, a system is provided (e.g., node 900 including memory within which a migration tool 102, implementing semantic model automation functionality 103, is stored). The system includes a means for creating a table list dictionary of tables of a project hosted by a first reporting platform according to a first format, wherein the table list dictionary includes a schema, table names of the tables, and usage frequency of the table names within a query targeting the project (e.g., the processors 901 may execute instructions of the migration tool 102 within the memory 902 to utilize the semantic model automation functionality 103 to perform functions 602-626 to create the table list dictionary). The system includes a means for generating display names for the tables included as part of converting the project into a model hosted within a second reporting platform according to a second format (e.g., the processors 901 may execute instructions of the migration tool 102 within the memory 902 to utilize the semantic model automation functionality 103 to perform functions 602-626 to generate the display names). The system includes a means for determining an execution order of queries to the second reporting platform, wherein the queries include expressions and table queries (e.g., the processors 901 may execute instructions of the migration tool 102 within the memory 902 to utilize the semantic model automation functionality 103 to perform functions 602-626 to determine the execution order). The system includes a means for executing the queries according to the execution order to convert the project from the first format into the model in the second format utilizing the table list dictionary and display names (e.g., the processors 901 may execute instructions of the migration tool 102 within the memory 902 to utilize the semantic model automation functionality 103 to perform functions 602-626 to execute the queries).

In some embodiments, the system includes a means for appending security table details for the model (e.g., processors 901 executing function 608 and/or other functions of semantic model automation functionality 103).

In some embodiments, the system includes a means for creating the expressions within the model (e.g., processors 901 executing function 612 and/or other functions of semantic model automation functionality 103).

In some embodiments, the system includes a meaning for generating row level security rules for the tables based upon specified requirements; and means for generating data analysis expression logic for specified roles for the model (e.g., processors 901 executing function 614 and/or other functions of semantic model automation functionality 103).

In some embodiments, the system includes a means for creating relationships between the tables and columns for the model (e.g., processors 901 executing function 620 and/or other functions of semantic model automation functionality 103).

In some embodiments, the system includes a means for creating join conditions between the tables for the model (e.g., processors 901 executing function 622 and/or other functions of semantic model automation functionality 103).

In some embodiments, the system includes a means for converting backend table names for the model and appending alias names for the model (e.g., processors 901 executing function 620 and/or other functions of semantic model automation functionality 103).

In some embodiments, the system includes a means for analyzing, reformatting, and mapping columns of the tables to types supported by the second format of the second reporting platform (e.g., processors 901 executing function 620 and/or other functions of semantic model automation functionality 103).

In some embodiments, a method is provided. The method includes parsing query to identify components of a first database targeted by the query; executing the query to obtain an output from the first database, wherein the output has a first format; and utilizing, by a semantic model, the components to transform the output into an annotated output having a second format different than the first format of the output from the first database.

In some embodiments, the method comprises transforming the output into the second format used to populate a second database supporting the second format and not the first format.

In some embodiments, the method comprises utilizing the semantic model to: create a table list dictionary of tables including a schema, table names of the tables, and usage frequency of the table names within the query; generate display names for the tables; determine an execution order of queries to perform as part of obtaining the output, wherein the queries include expressions and table queries; execute the queries according to the execution order; and utilize the table list dictionary and display names to transform the output into the annotated output.

In some embodiments, the method comprises utilizing the semantic model to create, for the annotated output, at least one of security table details, expression, row level security rules, roles, data analysis expression logic for the roles, relationships between tables and columns referenced by the query, or join conditions for the tables.

In some embodiments, the method comprises utilizing the semantic model to convert backend table names and append alias names of tables referenced by the query.

In some embodiments, the method comprises utilizing the semantic model to analyze, reformat, and map columns of tables referenced by the query to types supported by second format.

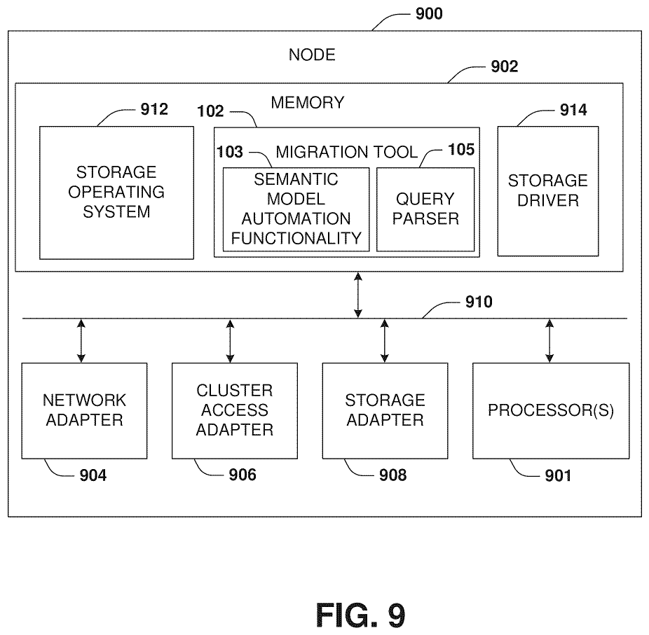

Referring to FIG. 9, a node 900 (also referred to as a storage node) in this particular example includes processor(s) 901, a memory 902, a network adapter 904, a cluster access adapter 906, and a storage adapter 908 interconnected by a system bus 910. In other examples, the node 900 comprises a virtual machine, such as a virtual storage machine.

The node 900 also includes a storage operating system 912 installed in the memory 902 that can, for example, implement a RAID data loss protection and recovery scheme to optimize reconstruction of data of a failed disk or drive in an array, along with other functionality such as deduplication, snapshot creation, data mirroring, synchronous replication, asynchronous replication, encryption, etc.

The network adapter 904 in this example includes the mechanical, electrical and signaling circuitry needed to connect the node 900 to one or more of the client devices over network connections, which may comprise, among other things, a point-to-point connection or a shared medium, such as a local area network. In some examples, the network adapter 904 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 908 cooperates with the storage operating system 912 executing on the node 900 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 908 can include I/O interface circuitry that couples to the disks over an I/O interconnect arrangement, such as a storage area network (SAN) protocol (e.g., Small Computer System Interface (SCSI), Internet SCSI (ISCSI), hyperSCSI, Fiber Channel Protocol (FCP)). The information is retrieved by the storage adapter 908 and, if necessary, processed by the processor(s) 901 (or the storage adapter 908 itself) prior to being forwarded over the system bus 910 to the network adapter 904 (and/or the cluster access adapter 906 if sending to another node computing device in the cluster) where the information is formatted into a data packet and returned to a requesting one of the client devices and/or sent to another node computing device attached via a cluster fabric. In some examples, a storage driver 914 in the memory 902 interfaces with the storage adapter to facilitate interactions with the data storage devices.

The storage operating system 912 can also manage communications for the node 900 among other devices that may be in a clustered network, such as attached to the cluster fabric. Thus, the node 900 can respond to client device requests to manage data on one of the data storage devices or storage devices of the distributed storage system in accordance with the client device requests.

A file system module of the storage operating system 912 can establish and manage one or more file systems including software code and data structures that implement a persistent hierarchical namespace of files and directories, for example. As an example, when a new data storage device (not shown) is added to a clustered network system, the file system module is informed where, in an existing directory tree, new files associated with the new data storage device are to be stored. This is often referred to as “mounting” a file system.

In the example node 900, memory 902 can include storage locations that are addressable by the processor(s) 901 and adapters 904, 906, and 908 for storing related software application code and data structures. The processor(s) 901 and adapters 904, 906, and 908 may, for example, include processing elements and/or logic circuitry configured to execute the software code and manipulate the data structures.

The storage operating system 912, portions of which are typically resident in the memory 902 and executed by the processor(s) 901, invokes storage operations in support of a file service implemented by the node 900. Other processing and memory mechanisms, including various computer readable media, may be used for storing and/or executing application instructions pertaining to the techniques described and illustrated herein.

In some embodiments, the migration tool 102 is implemented by the node 900 in order to parse and transform queries using the disclosed techniques described in relation to FIGS. 1-8. It may be appreciated that the migration tool 102 may be implemented by the node 900, a virtual machine, a serverless architecture, a container of a container orchestration platform, a cloud computing environment, or any other computing device or service.

The examples of the technology described and illustrated herein may be embodied as one or more non-transitory computer or machine readable media, such as the memory 902, having machine or processor-executable instructions stored thereon for one or more aspects of the present technology, which when executed by processor(s), such as processor(s) 901, cause the processor(s) to carry out the steps necessary to implement the methods of this technology, as described and illustrated with the examples herein. In some examples, the executable instructions are configured to perform one or more steps of a method described and illustrated later.

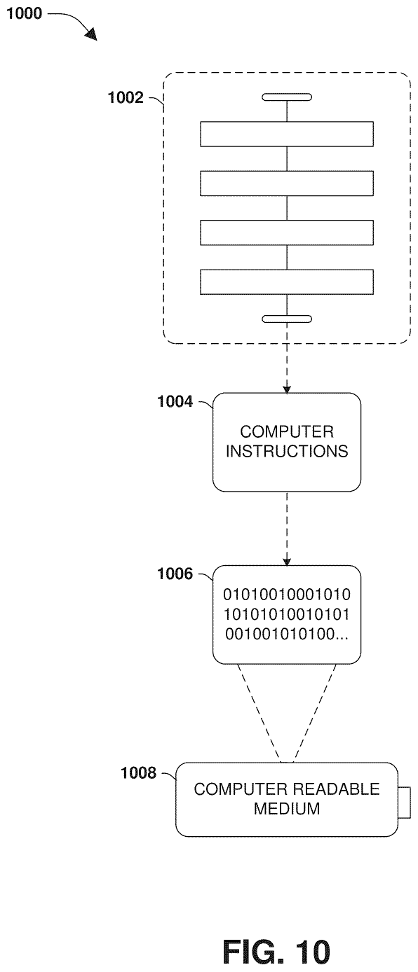

FIG. 10 is an example of a computer readable medium 1000 in which various embodiments of the present technology may be implemented. An example embodiment of a computer-readable medium or a computer-readable device that is devised in these ways is illustrated in FIG. 10, wherein the implementation comprises a computer-readable medium 1008, such as a compact disc-recordable (CD-R), a digital versatile disc-recordable (DVD-R), flash drive, a platter of a hard disk drive, etc., on which is encoded computer-readable data 1006. The computer-readable data 1006, such as binary data comprising at least one of a zero or a one, in turn comprises processor-executable computer instructions 1004 configured to operate according to one or more of the principles set forth herein. In some embodiments, the processor-executable computer instructions 1004 are configured to perform at least some of the exemplary methods 1002 disclosed herein, such as method 400 of FIG. 4 and/or method 700 of FIG. 7, for example. In some embodiments, the processor-executable computer instructions 1004 are configured to implement a system, such as at least some of the exemplary systems disclosed herein, such as system 100 of FIG. 1, system 200 of FIG. 2, system 500 of FIGS. 5A-5D, and/or system 800 of FIG. 8, for example. Many such computer-readable media are contemplated to operate in accordance with the techniques presented herein.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on. In some embodiments, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW)s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method executed by one or more processors, comprising:
analyzing a query targeting a project hosted by a source reporting platform to identify components of the source reporting platform used to host the project, the source reporting platform using a project based format to represent the project;
migrating the project from the source reporting platform to a destination reporting platform as a semantic model by transforming the project from the project based format to a semantic model based format used by the destination reporting platform, wherein the transforming includes:
sequentially executing a plurality of functions upon the components extracted from the source reporting platform to generate function outputs appended into a main model parameter of a structure encoded into the semantic model using an encoding technique to create the semantic model conforming to the semantic model based format; and
loading the semantic model into the destination reporting platform to provide access to the project migrated from the source reporting platform to the destination reporting platform.

2. The method of claim 1, comprising:
extracting a report from the source reporting platform, wherein the report is formatted according to the project based format;
converting the report to the semantic model based format as a reformatted report; and
migrating the reformatted report into the destination reporting platform, wherein the reformatted report includes a layout of the report.

3. The method of claim 1, comprising:
generating one or more model validation rules based upon a first format defined project standard;
applying the one or more model validation rules to the semantic model to determine whether the semantic model adheres to the project standard; and
in response to detecting a discrepancy between the semantic model and the one or more model validation rules, providing a notification of the discrepancy to a user.

4. The method of claim 1, wherein the plurality of functions comprise at least one of:
a table with columns function generating custom queries embedded with parameters derived from the components and storage modes assigned to renamed backend columns, wherein the custom queries are generated and mapped to reference tables in the destination reporting platform;
a query execution order function determining an execution order for the custom queries including expression queries and table queries; or
a table list function generating a dictionary with details relating to schema, table names, alias names, and usage frequency in the query

5. The method of claim 1, comprising:
generating code for inclusion within the semantic model to include one or more relationships amongst tables extracted as the components from the project; and
utilizing the code to recreate the tables in the semantic model and implementing the relationships for the tables.

6. The method of claim 1, comprising:
modifying code of the semantic model to implement security provided by the project for data stored within tables maintained by the source reporting platform.

7. The method of claim 1, comprising:
generating code for inclusion within the semantic model to include roles extracted as the components from the project; and
utilizing the code to implement the roles for accessing data within the semantic model.

8. A computing device, comprising:
a memory comprising machine executable code; and
a processor coupled to the memory, the processor configured to execute the machine executable code to cause the computing device to:
parse a query to identify components used by a source reporting platform to host a project in a project based format;
construct a custom query based upon the components to target a data repository storing the project;
execute the custom query against the data repository to extract data and metadata of the project from the components used by the source reporting platform to format the project;
create a semantic model conforming to a semantic model based format supported by a destination reporting platform using the data and metadata extracted from the source reporting platform by:
sequentially executing a plurality of functions upon the data and metadata extracted from the source reporting platform to generate function outputs appended into a main model parameter of a structure encoded into the semantic model using an encoding technique to create the semantic model conforming to the semantic model based format; and
load the semantic model into the destination reporting platform to provide access to the project migrated as the semantic model from the source reporting platform to the destination reporting platform.

9. The computing device of claim 8, wherein the machine executable code causes the computing device to:
reformat a column within a table extracted as a component from the project based format to create a reformatted column within the semantic model.

10. The computing device of claim 8, wherein the machine executable code causes the computing device to:
determine that a column within a table extracted as a component from the source reporting platform had a hidden attribute to hide the column from one or more end users;
recreate the column within the semantic model as a recreated column to comprise data migrated from the column within the table extracted from the source reporting platform; and
apply the hidden attribute to the recreated column.

11. The computing device of claim 8, wherein the machine executable code causes the computing device to:
extract an expression as a component from the source reporting platform; and
generate and utilize code to recreate the expression in the model according to the semantic model based format.

12. The computing device of claim 8, wherein the machine executable code causes the computing device to:
create a table list dictionary including a schema, table names of tables used to store the data and metadata of the project, and usage frequency of the table names within the query; and
utilize the table list dictionary to extract the data and metadata from the source reporting platform.

13. The computing device of claim 8, wherein the machine executable code causes the computing device to:
extract annotations as the one or more components from the source reporting platform; and
generate and utilize code to recreate the annotations in the semantic model according to the semantic model based format.

14. The computing device of claim 8, wherein the machine executable code causes the computing device to:
extract at least one of measures, filters, or calculated columns as the one or more components from the source reporting platform; and
generate and utilize code to recreate the components in the semantic model according to the semantic model based format.

15. The computing device of claim 8, wherein the machine executable code causes the computing device to:
analyze, reformat, and map columns of tables referenced by the query to types supported by the semantic model based format inclusion within the semantic model.

16. The computing device of claim 8, wherein the machine executable code causes the computing device to:
dynamically generate one or more parameters for extracting the data from the components, wherein the one or more parameters are dynamically generated by a query parser that parses the query targeting the source reporting platform;
construct the custom query using the one or more parameters; and
execute the custom query against the source reporting platform to access the data and metadata from the components.

17. A non-transitory machine readable medium comprising instructions, which when executed by a machine, causes the machine to:
analyze a query to identify components used by a source reporting platform to host a project formatted according to a project based format;
migrate the project from the source reporting platform to a destination reporting platform as a semantic model by transforming the project from the project based format to a semantic model based format used by the destination reporting platform, wherein the transforming includes:
sequentially executing a plurality of functions upon the components extracted from the source reporting platform to generate function outputs appended into a main model parameter of a structure encoded into the semantic model using an encoding technique to create the semantic model conforming to the semantic model based format; and
load the semantic model into the destination reporting platform to provide access to the project migrated from the source reporting platform to the destination reporting platform as the semantic model.

18. The non-transitory machine readable medium of claim 17, wherein the instructions cause the machine to:
extract a column as a component from the source reporting platform;
reconstruct the column according to the semantic model based format to create a reconstructed column within the semantic model; and
rename the reconstructed column to differ from a name of the column within the source reporting platform.

19. The non-transitory machine readable medium of claim 18, wherein the instructions cause the machine to:
create at least one of security table details, expressions, or row level security rules for the semantic model.

20. The non-transitory machine readable medium of claim 17, wherein the instructions cause the machine to:
create at least one of roles, data analysis expression logic for the roles, or relationships between tables and columns referenced by the query for the semantic model.
